(19) United States
(12) Patent Application Publication
(10) Pub. No.: US 2002/0197989 A1
(43) Pub. Date: Dec. 26, 2002

(54) Wireless telephony interface and method

(76) Inventors: Olivier Cruder, Saskatoon (CA); Michael David Lockerbie, Saskatoon (CA); Duane J. Sniezek, Calgary (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/018,942

(22) PCT Filed: Feb. 22, 2001
(86) PCT No.: PCT/CA01/00214

(51) Int. Cl. H04Q 7/20

(52) U.S. Cl. 455/426; 455/401

(57) ABSTRACT

Telephone networks require an expensive physical infrastructure of transmission lines or cables. Building such an infrastructure may not be economically feasible in remote or sparsely populated areas which lack the necessary wealth or demand. Wireless connections provide an inexpensive alternative, but attempts to date using communication satellites and cellular systems, all have serious shortcomings. The invention provides a cost-effective system which interconnects a standard telephony device with the PSTN via a transparent, wireless link, the wireless link being provided at respective ends, by a stand-alone communication interface which includes a convertor for receiving audio signals, including in-band DTMF signals, from a telephony device and converting those received signals into digital data; and a point to point wireless transmitter which receives the digital data and transmits it at a radio frequency via an external antenna.

The present invention relates generally to telecommunications, and more specifically, to an interface and method of interfacing which allows telephones, pay telephones, fax machines, modems and other similar devices to be transparently connected to a public switched telephone network (PSTN) via a wireless link.

### BACKGROUND OF THE INVENTION

Telephones are widely used in industrialized countries to provide convenient and reliable voice communications, whether for business, social, emergency or other purposes. Access to telephone communications is taken for granted in private environments such as homes, businesses and hotels, but is also generally available in public places including restaurants, shopping malls, and sports arenas. Private telephones are typically owned or rented, and a monthly fee paid to a local exchange carrier (LEC) for basic services such as local calling. Providers of public pay telephones endeavour to recover the costs of installation and maintenance by charging users for each use. Pay telephones may accept various forms of payment including, for example: cash, credit card, smart card, pre-paid card, debit card or charging the cost of the call to the called party, a third party or calling card number.

Typical telephone networks require physical transmission lines or cables to interconnect individual telephones with the end offices and switches which make up the public switched telephone system (PSTN). Building such a pervasive physical infrastructure may come at a substantial cost. As well, the incremental cost of running physical transmission lines to remote or sparsely populated areas may be considerable, even in industrialized countries.

Thus, in geographically remote areas and in areas of the world without the necessary wealth or demand, it may not be economically feasible to build and maintain an expensive physical infrastructure. There is therefore a need for an inexpensive alternative to physical telephone lines.

Attempts have been made to interconnect telephones and pay telephones with the PSTN by use of wireless connections, but the existing systems suffer from serious shortcomings.

One approach is to provision the wireless link using communication satellites such as geostationary or low earth orbit (LEO) satellites, which have a number of limitations. For example:

1. their capital cost is very high;

2. they have a finite number of communication channels available whose use is usually committed long before the satellite is fabricated and launched;

3. because of the great distance between the user and the satellite, the user's transceiver must either track the target satellite or use sufficient power levels to make omnidirectional antennas effective. As transmission power is increased, the frequency spread between communication channels must increase to avoid inter-channel interference, which consumes bandwidth. As well, greater power levels will limit battery life and generally make solar power impractical;

4. the satellites themselves will project their transmissions towards a specific and limited geographical area which cannot be easily altered, if at all;

5. the technical complexity of these systems makes them expensive to manufacture and maintain; and

6. it is difficult or impossible to modify or update software or hardware on these systems.

The different types of satellite systems also have other limitations, depending on the system, which make them impractical for this application. Geostationary satellites for example, must be located in a specific belt (called the Clarke belt), which lies at a specific altitude and in the plane of the Earth's equator. There is a limit to the number of geostationary satellites that can be placed in the Clarke belt, and hence a limit to the number of satellites that can service a certain geographic area.

LEO satellites lie in lower orbits than geostationary satellites so they must move faster than the rotation of the Earth to stay in orbit. Therefore, a network of LEO satellites is required to provide continuous service in a given coverage area, one satellite entering the coverage area as another leaves. A large number of satellites are required in a LEO system, with complex controls, as the communication with the user must be handed off from satellite to satellite as the satellites move in and out of the user's coverage area.

There are also other satellite systems, such as geosynchronous and middle Earth orbit (MEO) systems, which have similar or additional problems.

As an alternative to satellites, some remote telephone systems use cellular telephone technology to provide the wireless link. Cellular telephone systems are characterised by multiple, spaced-apart base stations, each base station serving a separate geographic area or “cell”. The cellular base stations are linked to a computerized central switching centre that interfaces with the local telephone network central office. The use of cells allows the service provider to use the same frequency channels for customers in different cells. For example, if a cellular provider has a license for twenty wireless channels, and divides a service area into ten cells, he can carry up to two hundred calls simultaneously rather than just twenty. Spectrum management in cellular telephone systems is typically far more complex as transmissions are generally also multiplexed by time divisions or coding; this example is only intended to explain the cellular concept itself.

Cellular telephone systems typically maximize the use of the available frequency spectrum at the expense of voice quality. Cellular systems generally optimise spectrum usage by minimizing transmission power to produce a predetermined level of error, which allows as many voices as possible to be carried on the available channels. Hence, voice quality is lower then the quality of a standard PSTN (referred to as “toll quality”).

Cellular systems are designed for mobile users, where calls must be handed from one to another as the user moves about. Thus, in addition to having poor voice quality, cellular systems must have considerable complexity and cost. As well, a license is required to operate cellular telephone systems in most jurisdictions.

Wireless telephone systems which are currently available, regardless of whether they use cellular or satellite technology, are generally dedicated devices which can only be used with a specific system due to their proprietary design. Pay telephones which communicate with satellites for example, are available as integral pay telephone/wireless transceiver units. Because of their proprietary design, they are expensive, and the user is bound to use the service that the wireless telephone was designed for.

There is therefore a need for a system and apparatus which allows remote telephones and pay telephones to be connected to the PSTN without a hardwired connection. This design must be provided with consideration for the problems with existing wireless solutions, including complexity and cost.

### SUMMARY OF THE INVENTION

It is therefore an object of the invention to provide a novel interface and method of interfacing which allows telephones, pay telephones, fax machines, modems and other similar devices to be transparently connected to a public switched telephone network (PSTN) via a wireless link, which obviates or mitigates at least one of the disadvantages of the prior art.

One aspect of the invention is broadly defined as a stand-alone communication interface comprising: a convertor for receiving audio signals including in-band DTMF signals, from a telephony device and converting the received signals into digital data; and a point to point wireless transmitter for receiving the digital data and transmitting the digital data at a radio frequency via an external antenna.

Another aspect of the invention is defined as a stand-alone communication interface comprising: convertor means for receiving audio signals including in-band DTMF signals, from a telephony device and converting the received signals into digital data; and a point to point wireless transmitter means for receiving the digital data and transmitting the digital data at a radio frequency via an external antenna.

Another aspect of the invention is defined as a method of operating a stand-alone communication interface comprising the steps of: receiving audio signals including in-band DTMF signals, from a telephony device; converting the received signals into digital data; and transmitting the digital data at a radio frequency, using point to point wireless via an external antenna.

A further aspect of the invention is defined as a method of operating a stand-alone communication interface comprising the steps of: receiving digital data at a radio frequency, using point to point wireless via an external antenna; converting the digital data into audio signals including in-band DTMF signals; and passing the audio signals including in-band DTMF signals to a public switched telephone network.

### BRIEF DESCRIPTION OF THE DRAWINGS

These and other features of the invention will become more apparent from the following description in which reference is made to the appended drawings in which:

FIG. 1 presents a schematic diagram of a wireless interface system in a broad embodiment of the invention;

FIG. 2 presents a flow chart of a method for operating a wireless interface in a broad embodiment of the invention;

FIG. 3 presents a block diagram of a wireless interface circuit in a preferred embodiment of the invention;

FIG. 4 presents a schematic block diagram of a preferred telephone side T/R (transmit/receive) interface;

FIG. 5 presents a schematic block diagram of a preferred line-side T/R interface;

FIG. 6 presents timing diagrams of the burst frame structures used in a preferred embodiment of the invention;

FIG. 7 presents a flow chart of a method for establishing a wireless interconnection in a preferred embodiment of the invention;

FIG. 8 presents a timing diagram of the Master/Slave frame relationship used in a preferred embodiment of the invention;

FIGS. 9a and 9b present a flow chart of a method for placing a telephone call in a preferred embodiment of the invention;

FIG. 10 presents a flow chart of a method for completing a telephone call in a preferred embodiment of the invention; and

FIGS. 11a and 11b presents a flow chart of a method of receiving an incoming telephone call in a preferred embodiment of the invention.

### DETAILED DESCRIPTION OF PREFERRED EMBODIMENTS OF THE INVENTION

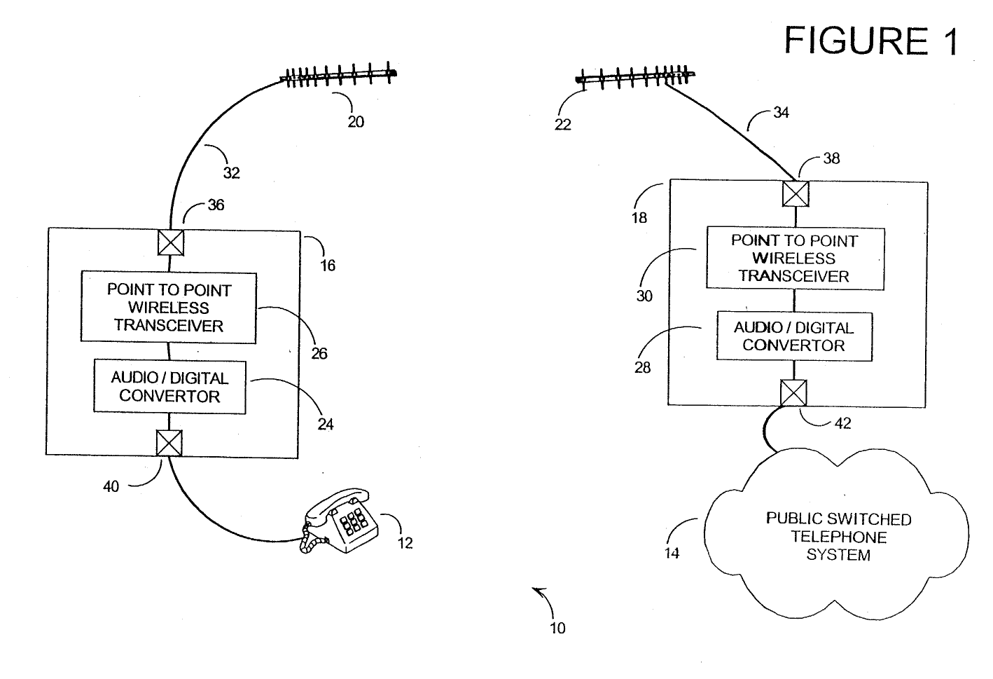

A system which addresses the objects outlined above, is presented as a schematic diagram in FIG. 1. This system 10 interconnects a standard telephony device 12 with a public switched telephone network (PSTN) 14 via a transparent, wireless link, the wireless link being provided at respective ends, by a stand-alone communication interface 16, 18 and antenna 20, 22. The telephony device 12 may be a telephone, pay telephone, fax machine or similar device, and its interface 16 includes:

1. a convertor 24 for receiving audio signals, including in-band DTMF signals, from the telephony device 12 and converting those received signals into digital data; and

2. a point to point wireless transmitter 26 which receives the digital data and transmits it at a radio frequency via an external antenna 20.

As telephone communications are generally bi-directional, the convertor 24 and wireless transmitter 26 will generally also have complementary functionality for receiving wireless data transmissions and converting them back to audio.

The interface 18 for the PSTN 14 similarly, also includes an audio/digital convertor 28 and point to point wireless transceiver 30. As will be described in greater detail hereinafter, the interfaces 16, 18 for the telephony device and PSTN sides of this system 10 are the same, except for the final device driver stage referred to herein as the telephone-side or line-side T/R (transmit/receive) interfaces.

In a traditional telephone system, dialled digits are communicated from the telephone to the telephone network as audio signals, either in a dual tone multifrequency (DTMF) mode (also known as TouchTone™), or in a pulse mode. While some wireless systems encode dialled DTMF digits as digital codes, the interfaces 16, 18 of the invention do not treat these audio signals any differently than the voice signal. While this requires marginally greater bandwidth than using digital codes, transmitting such non-voice telephone signals as in-band audio signals is a reliable and cost effective strategy. To begin with, the dialling signals are spread over a broader time period when they are audio coded, so there is an inherent redundancy and resistance to noise. Also, less complex encoding hardware and software is required as the voice and non-voice signals are encoded in the same manner, resulting in greater dependability and lower cost.

In contrast, pulse dialling generates an out-of-band signal in the same manner as the hook status of the telephony device. As described in greater detail hereinafter, out-of-band signals are encoded into the control channel of the wireless connection.

It is important to note that transmitting non-voice signals (such as DTMF signals) in the audio band also precludes the use of well known predictive voice encoders. As described in greater detail hereinafter, predictive encoders compress human voices digitally by making assumptions about the human voice. These assumptions do not hold for machine-generated tones such as DTMF signals, so predictive encoders would not effectively implement the system 10 of the invention.

As well, the use of a point-to-point wireless communication link precludes the use of cellular and satellite wireless systems. Such a system 10 uses a dedicated link which may always be on, while cellular channels may be busy, or out of range depending on weather conditions. Typical satellite and cellular systems use base stations (satellite or cell towers) which receive wireless signals and pass them through a network to be relayed to other base-stations for eventual transmission to the destination party. In the case of the invention, the wireless transmission comprises a single wireless link between two transceivers. Many different radio frequency bands may be used for wireless transmissions, though the use of wireless spectrum is generally tightly regulated in most jurisdictions. For example, some frequency bands may be used without a license, as long as certain transmission power levels are not exceeded.

In FIG. 1, both the telephone side and PSTN side are shown to have directional (Yagi) antennas 20, 22 though omnidirectional antennas could also be used. As the invention is generally expected to see fixed as opposed to mobile use, directional antennas are preferred as they have better performance and hence, longer range. These antennas 20, 22 are connected to their respective interfaces using cabling 32, 34 and connectors 36, 38 appropriate to the frequency and power level being used. In general, the cabling 32, 34 would be coaxial cabling which has integral shielding, while in the case of microwave frequency communications, for example, Heliac cabling is preferred. Such cabling 32, 34 and connectors 36, 38 are well known in the art.

The connector 40 on the side of the telephony device 12 also would be designed to mate with the intended telephony device 12 as appropriate. Generally, cable connectors and screw terminals are sufficient, though it may be desirable to use a modular telephone connector or other removable connector.

The connector 42 on the side of the PSTN 14 also would be designed as required by the application. Typically, it would consist of a cable connector and screw terminals, though it may consist of a line card connector which could be mounted in a rack or inside an existing telephone switch.

Providing this interface 16, 18 as a stand-alone device provides greater flexibility and lower cost when compared to integral devices available in the art. For example:

1. it can interface with any standard telephony device including pay telephones, regular telephones, fax machines and modems. This allows the interface 16, 18 to be mass produced, economy of scale reducing the cost per interface. The interchangeability of interfaces 16, 18 also makes maintenance easier and maintenance costs lower, as service providers do not have to stock a large variety of specific interface cards;

2. because the invention can be design to meet telephony interface standards, users can upgrade their telephony device 12 without having to purchase a new interface 16. As noted above, some wireless systems integrate the wireless transceiver with the pay telephone, so when either one becomes obsolete, both must be replaced; and

3. telephone service providers do not face ongoing costs associated with being bound to a particular proprietary wireless system. For example, satellite systems may only be compatible with a singe satellite service for a given geographic area, so the purchaser will be bound to use that satellite service, and pay ongoing service fees.

The interface 16, 18 of the invention allows a full-featured, transparent wireless link to connect a telephone or public payphone 12 to a central office (CO) or end office (EO) of the public switched telephone network (PSTN) 14 providing an alternative to the physical wire lines traditionally used. The primary benefit of the invention over hard wired systems is that it can provide a less costly means of servicing locations that are otherwise too remote, inaccessible or environmentally hostile. The invention can also be used in temporary installations or other installations where the high cost of a physical installation cannot be rationalised.

Thus, the invention may be used in many environments and for many applications including for example:

1. temporary applications such as construction sites, sporting events, exhibitions, site testing and evaluation, and demonstrations;

2. remote locations including rural water and sewage utility systems;

3. infrequent uses such as house to barn for agricultural use;

4. emergency communication systems such as road side telephones, police and fire department communications;

5. institutional public phone; and

6. wireless last mile.

Some of the advantages of the invention include:

1. reduced installation cost and time;

2. reduced maintenance cost;

3. portable public telephone access; and

4. adaptability to changes in site layout.

The invention also has many advantages over wireless alternatives, particularly cellular and satellite telephone implementations. Wireless cellular solutions for example, are restricted to areas where cellular coverage is available. The invention however, is a self-contained system which requires only two transceivers and therefore provides coverage wherever it is needed. Further, the invention supports loop polarity answer supervision. This is the traditional method employed in wired telephone installations; in contrast, cellular and cordless payphone solutions must rely on less reliable approaches.

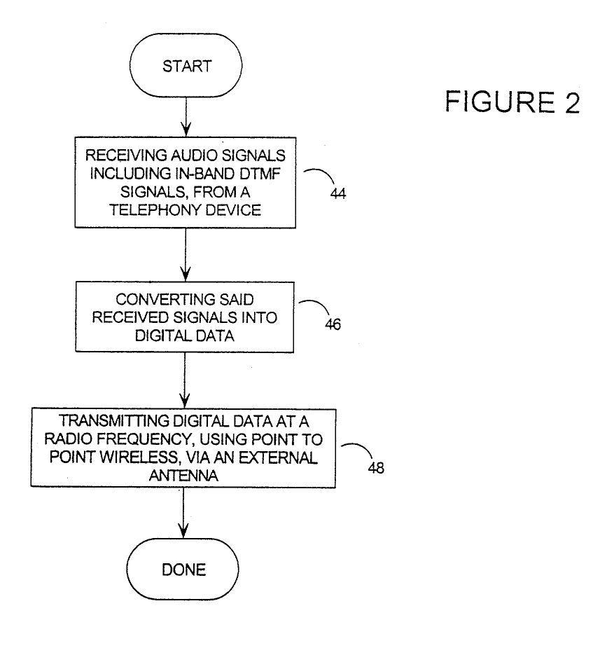

The invention has thus far been described with respect to an exemplary apparatus and system. However, a number of devices may be fabricated which could effect the broad method of the invention. FIG. 2 presents a flow chart of the broad method of the invention in terms of an interface for receiving audio signals from a telephony device, and transmitting those signals over a wireless link to a complimentary device in a remote location. This method includes the steps of:

1. receiving audio signals including in-band DTMF signals, from a telephony device per step 44;

2. converting the received signals into digital data per step 46; and

3. transmitting that digital data at a radio frequency, using a point to point wireless connection, via an external antenna per step 48.

The preferred embodiment of the invention operates in the 900 MHz ISM (Instrumentation, Scientific, and Medical) frequency band. Within certain power levels, a radio license is not required for ISM operation in most jurisdictions, resulting in significant cost savings and added convenience over devices operating in other frequency bands. As the unlicensed power transmission limit in the United States and Canada is 1 watt for the ISM band, the communication distance obtainable may be as much as 10 km, line of sight. However, the invention need not be limited to this frequency band.

The invention has been designed to be virtually transparent to the telephone system. Though wireless, it appears to both the PSTN 14 and telephony device 12 as a pair of wires connecting the two sides. Because of its transparency, the invention does not need to interpret dialling digits; instead, it simply passes any in-band signal including: voice, modem, music and DTMF tones as audio signals between the PSTN 14 and telephony device 12 just like a wire. Further, out-of-band signals (including hook status, loop polarity, and ringing) are also passed between the telephony device 12 and PSTN 14 just like a wire. As will be explained in greater detail hereinafter, in-band signals are encoded in ADPCM (adaptive differential pulse code modulation), while out-of-band signals are binary coded and transmitted with every frame.

The hardware of the line-side and telephone-side interfaces 16, 18 are sufficiently similar as to allow a single diagram to illustrated both devices. Both devices are identical by design with the exception of the T/R (transmit/receive) Interface section which deals with the specific interfacing requirements of the telephone and line sides.

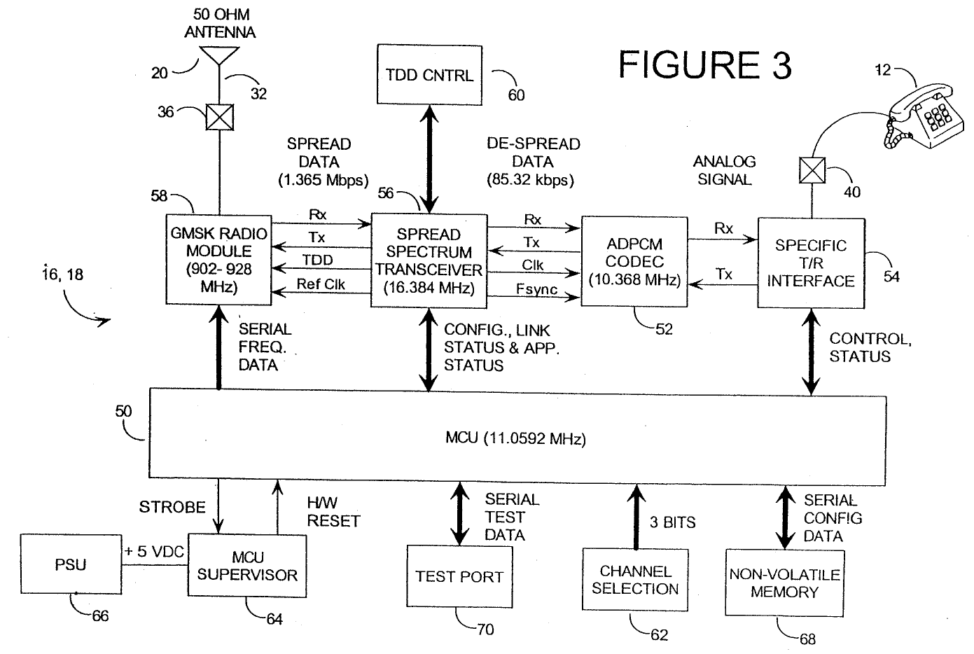

FIG. 3 presents an electrical schematic diagram of the interface 16, 18 in the preferred embodiment. In the interest of simplicity, only the major control and data lines are shown, and power and ground connections are not generally identified. Determining such details would be within the ability of one skilled in the art, and would vary depending on the specific integrated circuits used in the circuit.

The circuit is built around a micro controller unit (MCU) 50 which controls all aspects of device operation including oscillator frequency and pseudo noise (PN) sequence selection, but is not directly involved with data modulation. This functionality could be provided by a number of devices known in the art, or a combination of devices, including various microprocessors, micro controllers, digital signal processors (DSPs), field programmable gate arrays (FPGAs), application specific integrated circuits (ASICs), and glue logic.

In the preferred embodiment, micro controller model 87C52 from Philips Semiconductors is used for the MCU 50. It is an 8-bit, low power, high speed (up to 33 MHz) micro controller with a number of features that are particularly suited to implementing the invention, including:

selectable modes of power reduction including idle and power-down modes. The idle mode freezes the MCU 50 while allowing the random access memory (RAM), timers, serial port and interrupt system to continue functioning. The power-down mode saves the RAM contents but freezes the oscillator, causing all other chip functions to be inoperative. Idle mode is a suitable state for the MCU 50 to await incoming calls, or for the user to go off-hook;

256×8 internal RAM which holds firmware data-stores and a stack of program execution pointers;

three 16-bit counters/timers which are used to cause firmware actions to occur a fixed time after being set or periodically. In particular:

timer 0 is used to update a control word in the creation of the 20 Hz pseudo-sinusoidal reference ringing signal;

timer 1 generates the baud clock for the MCU's internal UART serial port. This port is used for device configuration, interrogation, and control; and

timer 2 is used as a generic time source that firmware may use for real-time events;

32 input and output (I/O) lines for communication with the other components of the interface as shown in FIGS. 3, 4 and 5. The details of these interconnections are described hereinafter;

an on-chip oscillator and clock circuit to minimize component count and board space. This circuit is driven with an external 11.0592 MHz crystal; and

a serial I/O port which is used to communicate with the external read only memory (ROM) 68.

Commercial communications equipment such as telephones and payphones should provide high-quality voice clarity, which is most effectively provided in wireless systems by digitally coding the voice signal. Many such codings are known, but in the preferred embodiment, the invention employs a PCM (Pulse Code Modulation) technique called ADPCM (adaptive differential pulse code modulation) and in particular, uses a 32 kbit per second ADPCM coder (coder/decoder) 52 which is compliant with CCITT standard G721.

In the preferred embodiment in-band audio signals are encoded in ADPCM while out-of-band signals are binary coded and transmitted with every frame. ADPCM compresses voice data more than PCM, this audio compression allowing the available transmission channels to carry more voices. This additional capacity comes at a minor compromise to reproductive quality, time delay and equipment cost.

Both PCM and ADPCM convert analogue voice signals into digital form by sampling the analogue signal 8000 times per second and converting each sample into a numeric code. PCM and ADPCM are “waveform” codec (coder/decoder) techniques, that is, they are compression techniques which exploit the redundant characteristics of the waveform itself. PCM simply interprets each signal sample as an individual voltage or current pulse at a particular amplitude. This amplitude is binary encoded, and the binary data transmitted or manipulated as required.

With differential pulse code modulation (DPCM) the analogue signal is sampled in the same manner as PCM. However, with DPCM, it is the difference between the actual sample value and a predicted value (predicted value is based on a previous sample or samples) that is quantized and then encoded to form a digital value. Hence, DPCM code words represent differences between samples, unlike PCM where code words represent sample values.

DPCM is generally more efficient than PCM because most audio signals show significant correlation between successive samples. Hence, encoding the differences between successive sample values requires fewer bits than encoding the samples themselves.

Adaptive Differential Pulse Code Modulation (ADPCM) is similar to DPCM in that differences between audio samples are encoded. In DPCM, those differences are encoded using a fixed number of bits; in ADPCM a fixed number, of bits are still used, but some of those bits are used to encode a quantization level. This way, the resolution of the difference can be adjusted. The performance is aided by using adaptive prediction and quantization, so that the predictor and difference quantizer adapt to the changing characteristics of the audio signal being coded. ADPCM coding gives reconstructed audio almost as good as 64 kbit per second PCM coding, at half the bit rate (32 kbit per second).

There are also “parametric” or “vocoding” techniques such as MP-MLQ (multi-pulse, multilevel quantization) and ACELP (adaptive code-excited linear prediction) coding which make assumptions about the human voice so they only have to transmit parametric data, requiring less bandwidth. However, these techniques produce mechanical sounding voice, and are poor at reproducing non-voice audio signals such as in-band DTMF or music. Hence, these coding techniques do not produce toll quality voice and are undesirable for in-band DTMF coding.

Voice compression techniques lose data with each transformation so it is desirable to keep the quality loss to a minimum if the data is be transformed several times. In the application of the invention, the data may be converted to ADPCM by the transmitting interface 16 then back to analogue by the receiving interface 18, then possibly to PCM which is common on digital PSTN systems, and finally decoding back to analogue at the end office of the called party. Hence, a high quality codec like ADPCM is desirable.

Another issue is that of time delays. ADPCM codecs typically require 1 mS to process a signal, resulting in a 1 mS delay in passing a voice signal. There are other coders which offer similar voice quality at a lower bit transmission rate, but these coders have longer delays. MP-MLQ and ACELP for example, use the channel capacity more efficiently, but have delays in the order of 30 mS. When other channel and processing delays are compounded the overall delay becomes unacceptable, a total end to end delay of 25 mS generally being regarded as the maximum acceptable. The preferred codec described herein below, has a maximum specified delay 0.2 mS, so the end to end delay of the complete system 10 of the invention is less than 10 mS.

If the coding/decoding is being performed by a device which is also used to perform other tasks, then the processing will be further delayed. Hence, in the preferred embodiment a dedicated device is used: a single rail ADPCM codec (coder/decoder) from OKI Semiconductor, model MSM7560. This ADPCM codec 52 performs mutual transcoding between the 300 to 3400 Hz analog tip and ring signal and a 32 kbps ADPCM full-duplex serial data stream. That is, it can convert an analogue voice or other audio signal in the range of 300 to 3400 HZ, to or from, 32 kbps ADPCM serial data. Full-duplex refers to fact that it can provide simultaneous coding and decoding without compromising the reproductive quality or time delay. The coding and decoding channels of this device are independent, except that they share the same clock, control and power inputs.

As this ADPCM codec 52 restricts the signal to noise ratio (SNR) of the audio signal path, modem data rates of no higher than 14.4 kbps can be expected. This is sufficient to support 1200 baud (Bell 212), and V.32 bis with V.42 error correction.

As shown in FIG. 3, the ADPCM codec 52 passes analogue data to and from the T/R Interface 54, and de-spread digital data to and from the spread spectrum transceiver (SST) 56. It also receives synchronous serial clock and frame-synchronization signals from the SST 56. The OKI ADPCM codec is a low powered device that requires only a single 5 VDC power supply, and is ITU G.721 (32 kbps) compatible, mu-law or linear selectable.

The T/R Interface 54 is the section which ultimately drives the telephony device 12, or connects the interface 16, 18 to the PSTN 14. Additional details regarding this section are included hereinafter.

The encoded audio and binary coded control signals are then passed to (or from) the SST section 56, which spreads the data over a broad frequency range before passing it to the GMSK radio module 58 for transmission.

Spread-spectrum techniques offer improved performance over narrow-band methods which transmit a single voice on a single channel. Spread-spectrum techniques divide a signal into discrete pieces which are transmitted at different frequencies within a predetermined frequency range. The codes which determine how the data is spread are unique to each user, and have low correlations between one another so that unwanted codes appear as noise and are easily rejected by receivers.

There are two main spread spectrum techniques: direct sequence spread spectrum (DSSS) and frequency-hopping spread spectrum (FHSS). In a FHSS system, the available frequency band is split into several channels, and the frequency at which a data stream is transmitted will hop from one channel to another. In DSSS systems, each bit of the data signal is modulated by a binary string called a pseudo noise (PN) sequence. Each 1 and 0 bit for each separate user in the system therefore has a distinctive coding. DSSS is preferred over FHSS in this application because it can carry a higher data rate, and has a longer range.

A PN sequence is not random as the name implies, but a deliberately selected set of codes that are orthogonal to one another (or almost orthogonal), so they can be easily distinguished by the receiver. However, when the coded signals are detected by a receiver which cannot decode them, they are rejected as noise because of their balance and apparent randomness. PN codes are well known in the art, and include orthogonal codes such as Walsh-Hadamard codes, and non-orthogonal codes such as M sequences, Gold codes and Kasami codes. These non-orthogonal codes are typically generated using shift register sequences.

The advantages of spread spectrum techniques in general include:

1. insensitivity to interference. Narrowband solutions will fail if interference occurs at the same frequency as the transmission. Because spread spectrum transmits data as separate pieces over many frequency channels, noise at a certain frequency will only interfere with a comparatively small portion of the data;

2. insensitivity to multi-path effects. If more than one copy of a transmitted signal arrives at a narrowband receiver (for example, a direct transmission and one which is reflected off a building), the two signals may be superimposed but spaced apart in time, causing distortion. In a spread spectrum environment, the receiver will only synchronize with one of the two received signals, and suppress the other.

3. security. Wireless signals may be easily intercepted by anyone with an appropriately tuned receiver, so unless a voice is encrypted, the interceptor can easily monitor a narrowband wireless communication. Because spread spectrum continuously changes the transmission frequency of the data or voice signal it is impossible for an outsider to intercept any significant portion the communication; and

4. spread spectrum techniques are allowed much higher transmission levels than narrowband signals at the same frequency, which generally extends the communication range and reliability. Wireless range is related to transmitted power levels which are governed by regulatory agencies such as Federal Communications Commission (FCC) in United States and Industry Canada in Canada. The power level used in unlicensed narrow-band transmission is severely restricted, which limits range.

Commercial communications equipment such as payphones should provide reliable, robust service, therefore, these first two advantages are very important.

The SST 56 used in the preferred embodiment is the AIC 9001 produced by ALFA Incorporated of Taiwan. The AIC 9001 is a DSSS integrated circuit with chip length 32 and a maximum data rate of 160 kbps (half duplex). This SST 56 performs a variety of functions including TDD (time division duplex) control, data spreading/de-spreading, reference clock generation, and radio and ADPCM codec interfacing.

The SST 56 buffers the codec data in order to convert between the 32 kbps full duplex codec data stream and the 85.33 kbps half-duplex on-air data rate used in the TDD scheme. The SST 56 uses a digital phase locked loop to maintain an equal read and write rate to the rate buffers to avoid FIFO (first in/first out) over/under-flow. Transmitter and receiver logic spreads/de-spreads the data to accommodate the on-air chip rate of 1.365 Mbps. The SST 56 also multiplexes and de-multiplexes overhead bits with the voice data which are required for link maintenance.

The SST 56 generates both the 16.384 MHz reference clock required by the radio and the 2.048 MHz serial clock required by the ADPCM codec 52. Operation of the SST 56 is governed by the MCU 50 via the configuration, link status and application status control lines, as shown in FIG. 3.

To decode, the receiver samples the incoming baseband signal at two samples per PN chip. The samples are then correlated with the four possible PN sequences in 64-bit parallel correlators. The de-correlated signal is demodulated via a digital phase locked loop.

The pseudo-noise (PN) sequence used to encode/decode each symbol is programmed by the MCU 50 according to the selected channel. Consecutive data frame bit-pairs are encoded as one of four symbols each with a unique 32-bit PN sequence. Data is further randomized by modulus-2 addition with a 2047-bit PN sequence. This operation smooths the output spectrum of the transmitted signal and eliminates discrete spectral components.

Each of eight channels corresponds to a unique set of four PN sequences as listed in Table 1.

TABLE 1
Pseudo-Noise Sequences

| Channel | A | B | C | D |
|---|---|---|---|---|
| 0 | 0xD6AD88D6 | 0x5598D6A5 | 0x96CAF149 | 0x67396869 |
| 1 | 0x68CAA59E | 0x0C8F4654 | 0xF1A8CBA4 | 0xF4405D7A |
| 2 | 0x8C3CF515 | 0xA153ACD5 | 0x77066437 | 0xC18A55ED |
| 3 | 0xE9ADEBD8 | 0xC61E7A8A | 0x4DF29B0C | 0x1368D79A |
| 4 | 0x78D465D2 | 0xAC5AD2B2 | 0xC4823B50 | 0x655D9D14 |
| 5 | 0x50BAA739 | 0xBB83321B | 0x42A759AB | 0x8CE2E3C3 |
| 6 | 0x054C5513 | 0x8EA24F87 | 0xD435C92B | 0x4F5168B5 |
| 7 | 0x83E80A70 | 0xF33C8196 | 0x129596FA | 0x087A249A |

The TDD controller 60 implements a protocol that allows a full-duplex link to be emulated by the half-duplex SST 56 simply by alternating direction of data flow through the communication channel, thus only one channel is required for two way communication. This alternation is desirably fast enough that there is no perceptible delay in real time, or degradation in voice quality; in the preferred embodiment, a 9 mS cycle is used. The TDD controller 60 also generates the TDD control signals and the frame-synchronization signals required by the GMSK Radio Module 58 and ADPCM codec 52 respectively.

The digital spread signal is modulated onto the analog carrier frequency using Gaussian-filtered Minimum Shift Keying (GMSK) in the GMSK Radio Module 58. GMSK is a form of frequency shift keying which shapes pulses to minimize spectral leakage, by passing them through a Gaussian shaped impulse response filter. The spurious radio emissions, outside of the allotted bandwidth, are controlled to limit adjacent channel interference.

GMSK was selected over other modulation schemes as a compromise between spectral efficiency, complexity of the transmitter, and limited spurious emissions. For example, GMSK is more power efficient than DQPSK (Differential Quadrature Phase Shift Keying), which is commonly used on cellular telephone systems. As well, GMSK is not disturbed by amplifier non-linearity in the same manner as DOPSK.

As noted above, the transmit chain of the GMSK Radio Module 58 filters base-band spread signal data with a Gaussian spectral shape. The resulting signal then directly modulates the voltage controlled oscillator (VCO) in the 902-928 MHz ISM band. Each of eight channels has a unique carrier frequency.

The carrier and local oscillator (LO) frequencies used in the preferred embodiment are listed in Table 2.

TABLE 2
VCO Frequencies

| | VOC Frequency - | VCO Frequency - |
|---|---|---|
| Channel | Transmit Carrier [MHz] | Receive LO [MHz] |
| 0 | 924.928 | 968.960 |
| 1 | 922.624 | 966.656 |
| 2 | 920.064 | 964.096 |
| 3 | 917.504 | 961.536 |
| 4 | 914.944 | 958.976 |
| 5 | 912.640 | 956.672 |
| 6 | 910.336 | 954.368 |
| 7 | 908.032 | 952.064 |

Additional channels in the ISM band could also be used (subject to regulatory restrictions). As well, the channel frequency spacing could also be narrowed, though this would increase inter-channel interference (channel spacing is generally governed by national regulations).

The receiver chain performs down-conversion of the radio frequency (RF) signal to an intermediate frequency (IF) of 44 MHz using a super-heterodyne topology, and then demodulates the GMSK IF to base-band. The GMSK radio module 58 operates in time-division duplex mode (TDD) with a 9 mS cycle time so it does not transmit and receive simultaneously. The on-board VCO receives a 16.384 MHz reference clock from the SST 56, and the local oscillator (LO) tunes the lower side-band (LSB) to the IF for subsequent GMSK demodulation. Signals from the TDD controller 60 (built into the spread-spectrum transceiver 56 or “SST”) directly control the transmit/receive status of the GMSK Radio Module 58. Additionally, voice and radio-link overhead data are piped between the data ports of the SST 56 and GMSK Radio Module 58.

In the preferred embodiment, the GMSK Radio Module 58 used is the ARF 9003 from ALFA Incorporated of Taiwan. The ARF 9003 provides 70 overlapped channels or 10 non-overlapped channels, and a measured output power of 16 dBm at 5 VDC or 14 dBm at 4.5 VDC power supply.

The Channel Select section 62 allows user input for selection of one of eight communications channels. In the preferred embodiment only eight channels are used, so the channel select 62 is conveniently performed using a three pole, single throw DIP (dual in-line package) switch mounted on the circuit board. Alternative methods of channel selection would be clear to one skilled in the art; for example, at one extreme, the interfaces 16, 18 could be factory set to a certain channel. At the other extreme, the interfaces 16, 18 could negotiate channels to avoid conflicts with other interfaces 16, 18, or have a channel assigned by a Master.

The power supply unit (PSU) 66 supplies whatever power is required by the specific design. In the preferred embodiment, only +5 VDC is required, which can be provided by rechargeable or disposable DC batteries, solar cells, or be converted to DC from a local AC power source.

The MCU Supervisor 64 monitors power supply 66 quality and MCU 50 operation, and provides a controlled halting and restarting of the MCU 50 via a non-maskable interrupt to the MCU 50 when needed.

In the preferred embodiment, the Dallas Semiconductor DS1706 micro-monitor is used for the MCU supervisor 64 which provides a controlled halting of the MCU 50 when the power supply voltage drops below a pre-set minimum, either due to a brown-out or total failure, either of which could otherwise cause errors to occur. This component also allows a manual pushbutton to stop and reset the MCU 50, which requires debouncing of the pushbutton when pressed (removing voltage fluctuations due to mechanical vibrations) and controlling the timing of the power down and up of the MCU 50. Finally, it also provides a watchdog timer which resets the MCU 50 if a strobe input is not received from the MCU 50 every second. The MCU 50 strobes (pulses) the watchdog circuit periodically to prevent the circuit from causing a hardware reset function. This relationship assures that firmware is operating properly; if firmware stops strobing the watchdog then something is wrong and the system should be reset.

The non-volatile memory 68 provides a memory space for configuration parameter storage and retrieval which retains its stored data on power down. In the preferred embodiment, the Fairchild FM93C66 is used: a 4096-bit electrically erasable programmable read only memory (EEPROM) organized in a 256×16 bit array. Serial data input and output allows the memory to be packaged in an 8 pin DIP (dual in-line package) or SMT (surface mount technology) device taking up very little board space and making it low in cost.

Besides the serial data input and output pins, there are only two other connections to this non-volatile memory 68: a serial clock input which synchronises the non-volatile memory 68 with the MCU 50, and a chip select input which is used to trigger new memory cycles. All four connections go directly to the MCU 50. This particular device uses the Fairchild MICROWIRE interface which is compatible with many MCUs, but of course, the invention need not be so limited.

The interface 16, 18 also includes a serial test port 70 which provides a serial link (19.2 kbps maximum) between the interface of the invention and a computer. This serial test port 70 may be used to monitor operation, for configuration, to create specific test scenarios, or to load data. In the preferred embodiment, an RS485 port was used, provided by a 75176 integrated circuit. Of course, many other interface formats could be used including RS-232, USB, and other serial, parallel or proprietary designs.

As noted above, the T/R interface 54 will now be described in greater detail. The specification of the T/R interface 54 will vary with the particular phone or line side devices being used, but in general, it interfaces the specific tip and ring circuitry to both the ADPCM codec 52 and the MCU 50. The design of the T/R interface 54 will be described separately for the line and telephony device sides.

An interface 16, 18 which is to be connected to a telephony device 12 should look to the telephony device 12 like a loop-start central office (CO) with the following parameters:

600 Ohm AC impedance;

25 mA loop current max (could easily be increased, if required);

12 mA on/off hook detection threshold;

>40 VACrms 20 Hz sinusoidal ringing voltage at 1 REN (approximately 47 VACrms into a Nortel Millennium); and

−48 VDC battery voltage.

Loop start is the most common technique for access signalling in a standard PSTN end-loop network. When a handset is picked up (goes off-hook), this action closes the circuit that draws current from the telephone company's central office (CO), indicating a change in status. This change in status signals the CO to provide dial tone. An incoming call is signalled from the CO to the handset by sending a signal in a standard on/off pattern, which causes the telephone 12 to ring.

Another method of signalling on-hook or off-hook status to the CO is ground start, but this signalling method is primarily used on trunk lines or tie lines between PBXs. Ground start signalling works by using ground and current detectors. This allows the network to indicate off-hook or seizure of an incoming call independent of the ringing signal.

Hence, any device which can be plugged into a standard telephone outlet can also be connected to the telephone-side interface 16 of the invention, including for example: pulse and Touch-Tone™ or DTMF (dual tone multi-frequency) telephones, cordless telephones, computer modems or facsimile machines.

However, the preferred embodiment of the invention is the application to payphone telephones, and in particular, to the Nortel Millenium payphone. This system 10 provides a full featured, transparent, reliable and secure toll-quality wireless connection between a public telephone and the wire connection back to the central office. The Millenium telephone, for example, is operable to communicate status data back to the central office. The invention encodes these data into 14.4 kbps digital modem format to communicate over the wireless link. Hence, the preferred telephone-side T/R interface 54 has the parameters:

| | |
|---|---|
| Interface | >600 Ω, loop-start |
| Ringing load | <1 REN |
| Ring detect | 40-120 Vrms |
| Supply Voltage | 10 to 36 VDC |
| Supply Power | 2.5 W (max) |
| Power Termination | Screw Terminal (3 position) +/−/E |
| Loop Termination | Screw Terminal (2 position) T/R |
| Burst Sync Termination | Screw Terminal (4 position) M, D, /D, G |
| Cable Access | Through weather resistant strain relief |
| Antenna Termination | External reverse TNC connector |
| Protection | Primary, Secondary, UL 1459, CSA C22.2 No. |
| | 225 |
| Certification | IC CS03 Issue 8, FCC Part 68 Subpart D |

Other telephony devices 12 are easily accommodated and designing a suitable telephone-side T/R interface 54 would be straightforward to one skilled in the art from the teachings herein.

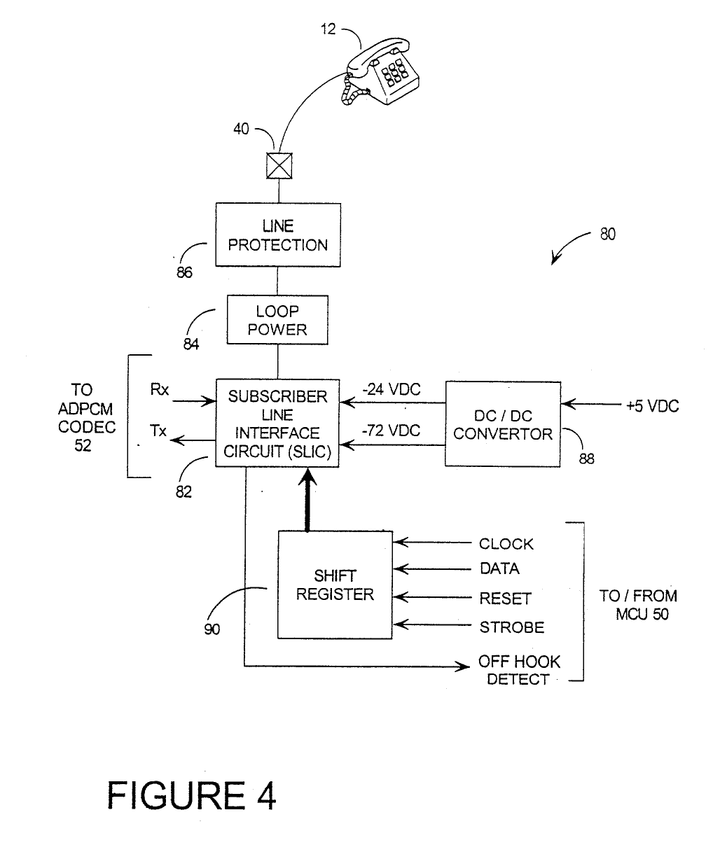

FIG. 4 presents a schematic block diagram of the preferred telephone-side T/R interface 80 designed to interface with the Nortel Millenium payphone.

At the heart of the telephone-side T/R interface 80 lies a Subscriber Line Interface Circuit (SLIC) 82 which provides the signalling requirements for the telephony device 12. In other words, the SLIC 82 mimics the signalling of the switching network, its functions including: −48 VDC battery, ringing voltage supply, overload protection, loop supervision and battery feed.

In the preferred embodiment, the Intersil HC55181 extended reach ringing subscriber line interface circuit (RSLIC) is used, which supports analogue plain old telephone service (POTS). It has the advantages of:

low power consumption;

robust auto-detection mechanisms for when subscribers go on or off hook. The on-hook signal is produced when the line loop between the telephone set and the central office (CO), or exchange, is open and no loop current exists. The off-hook signal is produced when the line loop is closed and loop current is present, which also powers a traditional POTS telephone. The off-hook detection signal is passed to the MCU 50 so that a digital pocket can be transmitted when a off-hook condition occurs;

low standby power consumption of 50 mW;

peak ringing amplitude 95V 5 REN (Ringer Equivalency Number). A value of 1 REN is the energy required to ring one traditional “Plain Old Telephone”. The REN number for a particular telephony device can be found on its FCC label. The total ringer load on a line is equal to the sum of all the REN numbers of all the telephone devices connected to the line;

integrated codec ringing interface;

integrated MTU DC characteristics;

low external component count, for example, single resistors are required to set each of: switch hook detect threshold, ring trip detect threshold, loop current limit and impedance matching;

provides feedback loop output to the codec front end to cancel echo. Echo is the phenomena of the user hearing his own voice in the telephone receiver while he is talking. When timed properly, echo is reassuring to the speaker, however; if the echo exceeds approximately 25 milliseconds, it can be distracting and cause breaks in the conversation;

tip open ground start operation;

integrated battery switch to reduce power consumption, low battery being selected for off hook conditions and high battery otherwise;

silent polarity reversal;

test access capability; and

both 2-wire and 4-wire ports, either of which may connect to the ADPCM 52.

The SLIC 82 connects to the telephony device 12 via a loop power source 84, and a line protector 86. The loop power source 84 simply provides DC loop power to the telephony device 12, while the line protector 86 will fail open, providing protection against lightning strikes and other potentially damaging transient voltages. The specifications of the loop power source 84 and line protector 86 are well known in the industry.

Because the main power to the interface 16 is +5 VDC, a DC/DC convertor 88 is necessary to provide −72 VDC and −24 VDC required by the SLIC 82. The use of a single +5 VDC source and DC/DC converter 88 makes it easy to use battery or solar power.

The −72 VDC supply provides the connected phone terminal with both the on-hook “battery voltage” as well as the ringing signal. Battery voltage is the nominal voltage seen on the tip and ring terminals of a telephone 12 while on-hook. It is traditionally supplied by the central office (CO), however, as the telephone side interface 16 is not electrically connected to the CO, the signal must be generated locally at the telephone side interface 16. A circuit internal to the SLIC 82 regulates the −72 VDC to the required battery voltage (nominally −48 VDC).

The ringing signal is the AC voltage seen on the tip and ring terminals of a telephone 12 while both on-hook and ringing. Again, it is traditionally supplied by the CO and so must be generated locally. A circuit internal to the SLIC 82 doubles the voltage and impresses an AC waveform upon it that is copied from a low voltage reference signal. The reference's wave shape and frequency are nominally pseudo-sinusoidal and 20 Hz.

The −24 VDC supply provides the connected telephone terminal 12 with off-hook loop current. Loop current is traditionally supplied by the CO's battery and is limited by the loop resistance and the resistance of the telephone terminal 12. As the telephone side interface 16 is not electrically connected to the CO, loop current is supplied locally. The −24 VDC supply powers a circuit internal to the SLIC 82 that limits the loop current to a preset value in order to reduce power consumption.

In the preferred embodiment, model NMT0572SZ from Newport Components is used for the DC/DC convertor 88. This device produces −24, −48 and −72 VDC isolated outputs from a +5 VDC input, though only the −24 and −72 are required in this embodiment of the invention. Like most of the components in the interface 16 of the invention, very few external discrete devices are required for support. In this case, the only discrete devices used were capacitors added to reduce output ripple.

The preferred telephone-side T/R interface 80 also requires a shift register 90, which interconnects the SLIC 82 with the clock, data, reset and strobe signals from the MCU 50. To augment the I/O capability of the MCU 50, 5 additional output lines are created by use of a latching serial to parallel shift-register. Three MCU 50 port pins present data, clock, and strobe signals to serially transfer data to the shift-register 90. These data control the 8 parallel output lines of the shift-register 90. Hardware reset is provided by the reset circuit. The 8 output lines control the state of the SLIC 82, its high/low battery status (−72 VDC/−24 VDC), as well as providing a control word to a resistor network that produces a given analog voltage. The control word is changed periodically to produce the 20 Hz pseudo-sinusoidal reference waveform that is required during ringing.

Three of the 8 output lines of the shift-register 90 control the state of the SLIC 82. These 3 bits select one of 6 states including:

low power standby: low power mode used for on-hook (maintains battery-voltage and hook supervision);

forward active: normal off-hook mode;

reverse active: off-hook mode with tip and ring terminals in reverse polarity;

ringing: on-hook ringing mode presents the ringing signal to the tip and ring pair;

tip open: used for “wink” anti-fraud measures to interrupt loop-current; and

power denial: lowest power mode (does NOT maintain battery-voltage or hook supervision).

A fourth output line selects the high or low battery (normally high for on-hook and low for off-hook).

In contrast, an interface 18 which connects the wireless link to the public switched telephone network (PSTN) 14, should look to the central office (CO) of the PSTN 14 like a loop-start telephone with the following parameters:

>600 Ohm AC impedance

<1 REN

40 to 120 VAC ring detection

In the preferred embodiment, the line-side T/R interface section 100 interfaces with a standard PSTN line which requires:

| | |
|---|---|
| Interface | 600 Ω, loop-start |
| Ringing Amplitude | >45 Vrms @ 1 REN |
| Ringing Frequency | 20 Hz |
| Ringer Waveform | Sinusoidal |
| Battery Voltage | −48 VDC |
| Loop Current | 25 mA |
| Supply Voltage | 10 to 36 VDC |
| Supply Power | 2.75 W (max) |
| Power Termination | Screw Terminal (2 position) +/− |
| Loop Termination | Screw Terminal (2 position) T/R |
| Burst Sync Termination | Screw Terminal (4 position) M, D, /D, G |
| Cable Access | Through weather resistant strain relief |
| Antenna Termination | External reverse TNC connector |
| Protection | Secondary, GR-1089-CORE |
| Certification | IC CS03 Issue 8, FCC Part 68 Subpart D |

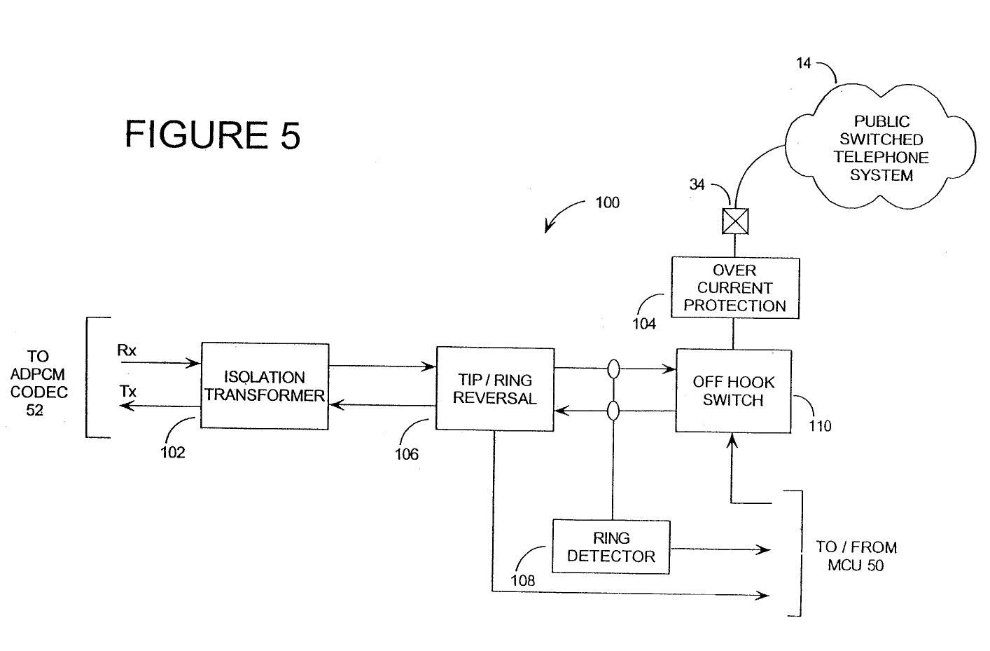

FIG. 5 presents a schematic block diagram of the preferred line-side T/R interface 100 designed to interface with the PSTN 14. An isolation transformer 102 interconnects the line-side T/R interface 100 with the ADPCM codec 52, and provides protection against accidental short-circuiting to ground. The line-side T/R interface 100 also includes overcurrent protection 104 on the interconnection with the PSTN 14, which protects the line-side T/R interface 100 from high current levels which may accidentally arrive from the PSTN 14.

Signalling which is not in the audio band is detected and digitally encoded for transmission over the wireless link. Hence, the following components are required:

1. tip/ring reversal section 106 which senses the current loop polarity. The MCU 50 continuously relays loop polarity status from the line-module to the phone-module so that the phone-module can reconstruct this state;

2. the output of the ring detection section 108 goes active while ringing. This signal is sent to the MCU 50 to be relayed to the phone-module for subsequent ringing signal reconstruction; and

3. off-hook switch section 110 which controls a relay that selectively routes tip and ring signals to the ring detection section 108 or to the tip/ring reversal section 106 (mutually exclusive).

As noted above, the design of the line-side T/R interface 100 depends on the particulars of the PSTN 14 in question, and is within the ability of one skilled in the art from the teachings herein.

Selection of an appropriate enclosure depends on the dimensions of the electrical components and the application environment. In the preferred embodiment, the invention is provided in a weather-proof enclosure with the specifications:

| Dimensions | 5.0″ × 6.5″ × 2.5″ (H × W × D) | |
|---|---|---|
| Weight | 3 lb | |
| Operating temperature | Standard | 0° to 50° C. |
| | Extended | −40° to 85° C. |

| | |
|---|---|
| Humidity | 0 to 95% non-condensing |

In public environments it is generally prudent for the enclosure to be tamper or vandal resistant as well.

In the preferred embodiment, the interface 16, 18 is also provided with light emitting diodes (LEDs) to indicate power on, and activity on the wireless link. The power indication is driven by the PSU 66, and the activity indication by the MCU 50. Other feedback to the user or local exchange operator is also possible.

Method of Operation

From the description of the device given above it would be straightforward for a skilled technician to assemble and operate the system 10 of the invention.

In the preferred embodiment, one device of the linked pair is designated the TDD Master, and the other the Slave, the Master and Slave each have unique roles in the TDD protocol. The Master initiates the communication link with the Slave using three frame formats during the set-up and maintenance of the TDD communications link.

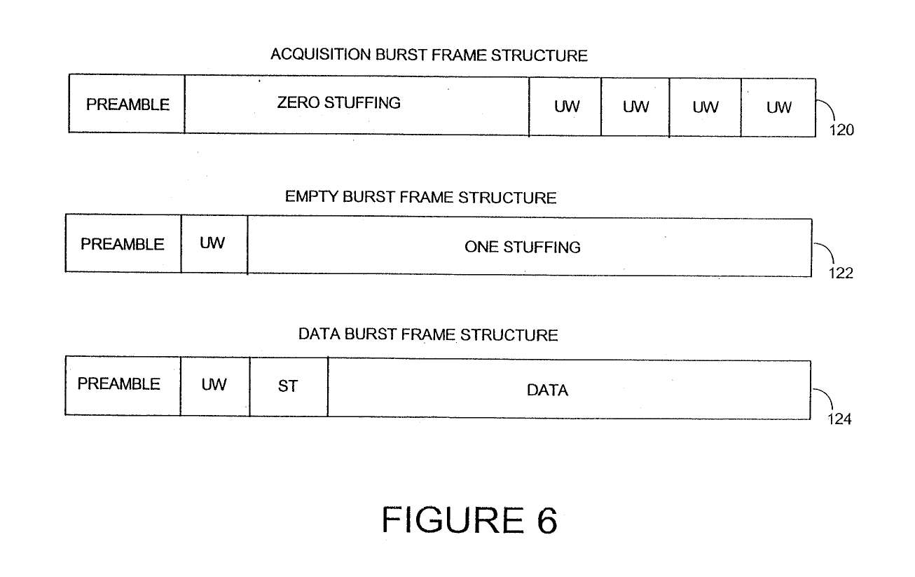

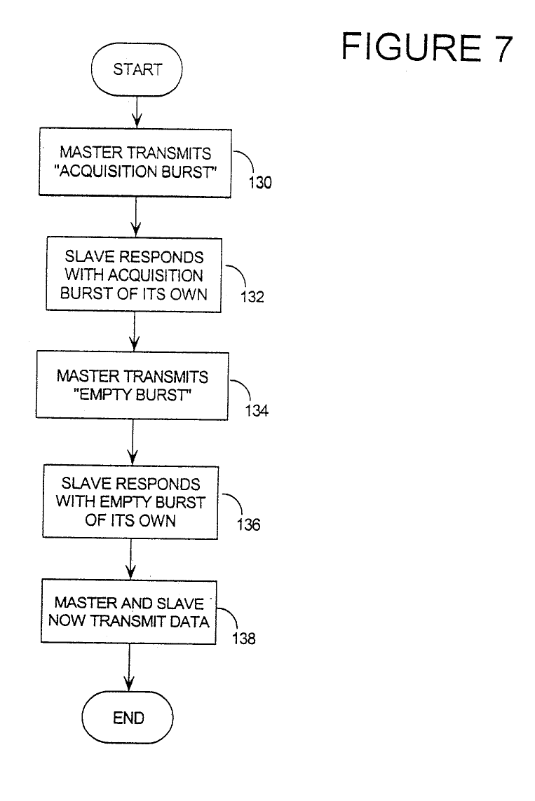

Initially, the two communicating interfaces 16, 18 need to establish “sync”. The TDD protocol achieves this by using a special handshaking protocol. The Master device first transmits an “acquisition burst” shown as frame 120 in FIG. 6, at step 130 of the flow chart in FIG. 7. The acquisition burst 120 consists of 32 bits of preamble (binary 0's), followed by 226 bits of “zero stuffing”, and four 22-bit unique words (UW). When the Slave device receives the acquisition burst 120 from the Master correctly (by decoding the 4 consecutive UW's) it sends an acquisition burst 120 in response at step 132. When the Master receives this acquisition burst 120, it returns an “empty burst” 122 at step 134. An empty burst 122 contains a 32-bit preamble followed by a single 22-bit unique word, and 292-bits of 1s (referred to as one-stuffing). In response to the Master's empty burst 122, the Slave also returns an empty burst 122 to the Master at step 136.

When the Master receives the empty burst 122 from the Slave, the communication link is considered to have been established and the “sync” condition achieved. On the following burst, both the Master and the Slave start genuine data transmission by sending out “data bursts” 124 at step 138. Each of the data bursts 124 contains a 32-bit preamble, followed by a 22-bit UW, a 4-bit status nibble (ST), and 288 bits of user data (ADPCM voice samples or data).

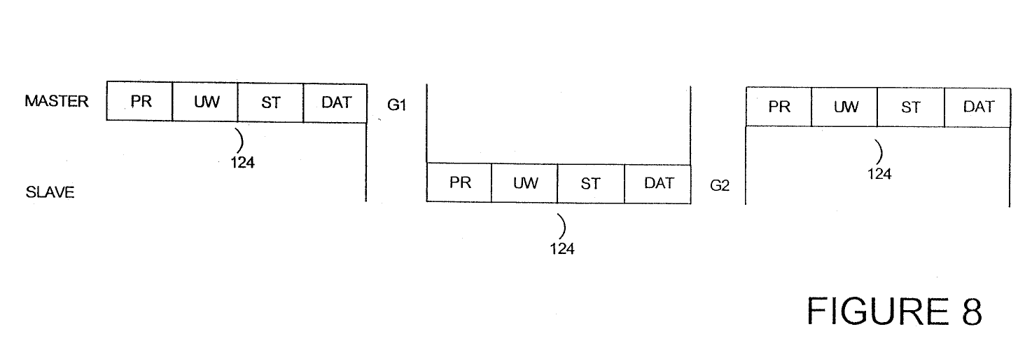

Each actual burst cycle also includes two guard times G1 and G2, as shown in FIG. 8, to allow for both propagation and RF transceiver switching time. More specifically, G1 is a 32-bit delay between the time when the Master stops transmission and the Slave commences transmission and G2 is a 32-bit delay between the time when the Slave stops transmission and the Master commences transmission. These guard times allow for a 375 μs delay. The total burst cycle is therefore 768 bits long, including 12 bits internal delay (transmitter turns off 6 bits after the last data bit is latched into the transmitter, the Master and Slave therefore contribute a total of 12-bit internal delay).

Implemented in the manner described herein above, the apparatus and system of the invention has been designed to be as transparent to the phone system as is possible. It monitors the hook-, loop polarity-, and ringing-status at the respective end, and relays this information digitally to the mating device which emulates that state. While off hook, it relays digital voice signals in full duplex.

Because of its transparency, the system does not need to interpret dialling digits. The hook status delay through the system (from the telephone 12 to the central office) is approximately 40 ms so that dial-tone is presented immediately upon going off-hook. Currently, the invention does not deny loop current if the wireless link is down, though it could easily be. If the wireless link is down, no dial tone will be present to the user when going off-hook.

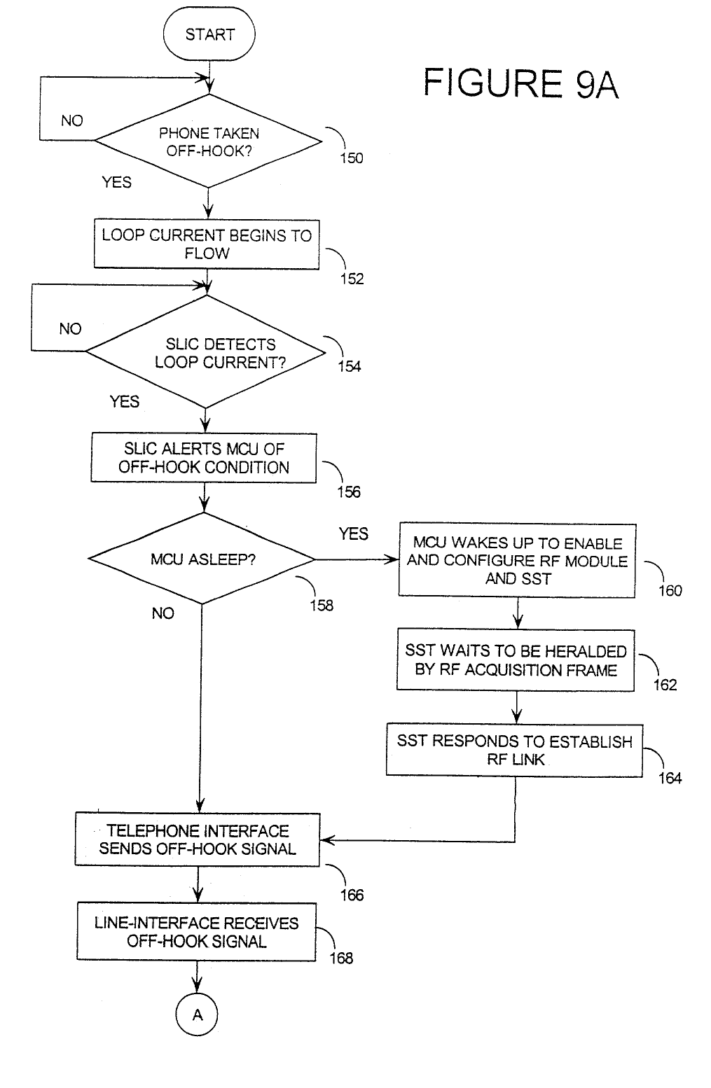

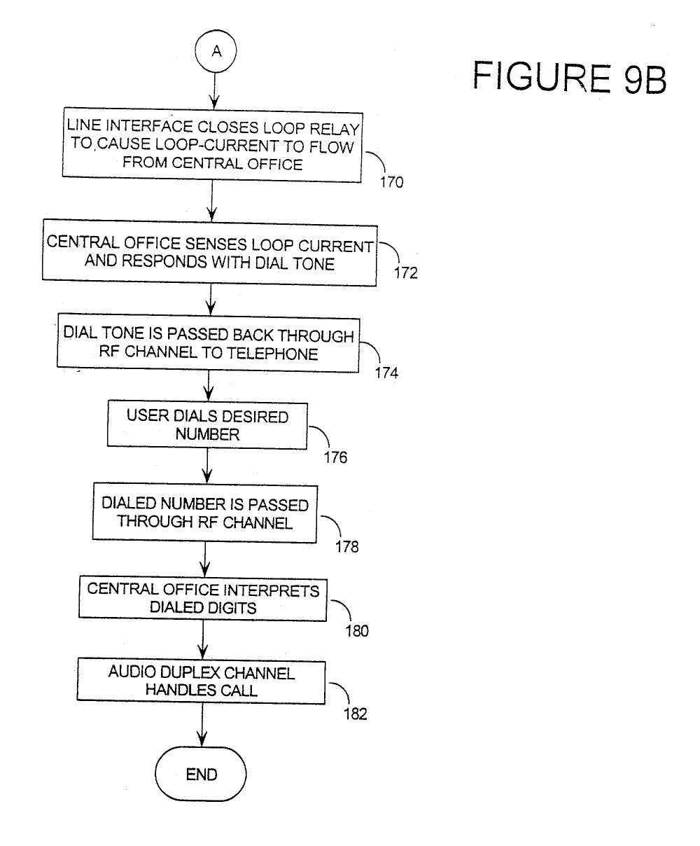

FIGS. 9a and 9b present the preferred method of operation when a call is placed is by the end user, on a standard telephone 12 connected to the telephone-side interface 16. When a standard telephone is taken off-hook (that is, the user picks up the receiver), a switch closes, allowing loop current to flow. The same steps occur in the system 10 of the invention, where, when the telephone 12 goes off hook at step 150, loop current provided by the telephone interface 16 begins to flow at step 152. The difference is that the loop current must be supplied by the telephone interface 16, while in the art, the loop current is provided by the central office. When this loop current is detected by the SLIC at step 154, it alerts the MCU 50 of the off-hook condition at step 156.

Per step 158, if the MCU 50 was asleep when the off-hook condition occurred, then:

1. the MCU 50 wakes to enable and configure the GMSK radio module 58 and spread spectrum transceiver (SST) 56 to accept an RF link at step 160;

2. the SST 56 waits to be heralded by the RF acquisition frame of the line-side interface 18 (that is, the line-side interface 18 continuously heralds); and

3. once detected, the SST 56 responds to establish the RF link.

Once the RF link is established in this manner, the telephone interface 16 and line interface 18 are able to exchange voice and status data in a full-duplex manner; voice data carries all in-band audio signals while status data carries all out-of-band signalling.

Alternatively, if the MCU 50 was already awake at step 158, then the RF link will already have been established.

With the RF link established, the telephone interface 16 sends an off-hook signal at step 166, which the line interface 18 receives at step 168. This transmission is a data signal which is transmitted by the ADPCM codec 52.

When the off-hook signal is received by the line interface 18, it closes a relay at step 170 of FIG. 9b, which causes current to flow on the PSTN 14 side of the system 10, emulating how a regular telephone would have effected the off-hook condition, The central office on the PSTN 14 senses the flow of the loop-current as it does in the art, and in response, returns a dial-tone at step 172 which propagates back thorough the RF channel to the telephone 12, per step 174.

The user is now free to dial desired digits at step 176, which are converted from audio to digital signals by the ADPCM codec 52, and passed over the RF channel. If the telephone 12 is set for DTMF dialling, the DTMF tones (audio signals) are passed through the system 10 transparently to the CO. Alternatively, dialling pulses pass through the system 10 transparently since the hook state (status signal) is continuously passed in real-time to the line-side interface 18 for subsequent emulation/re-creation. These digital signals are decoded by the ADPCM codec 52 in the receiving line interface 18 at step 180, and passed on to the PSTN 14. The CO interprets the DTMF tones or pulses in the traditional manner to form a switched connection, setting up the call in the manner known in the art. The RF channel remains open, so the user is able to handle his voice or data call at step 182.

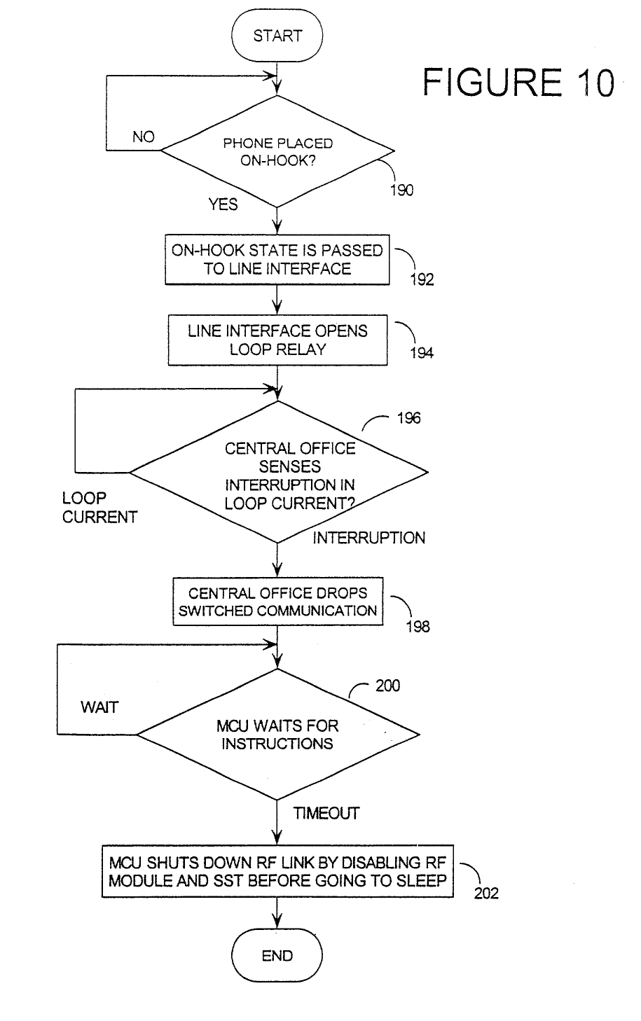

When the call is completed, the system 10 of the invention preferably follows the process of FIG. 10 to disconnect the call. This process begins when the caller goes “on-hook”, that is, hangs up his receiver at step 190. In a process complementary to that described with respect to FIGS. 9a and 9b above, this causes the loop current on the telephone interface 16 side to cease, which is detected by the SLIC 82, allowing it to communicate this event over the RF channel to the line interface 18 at step 192. The line interface then opens the loop relay, causing loop current to the PSTN 14 to cease at step 194. The central office detects the interruption in loop current at step 196, in the manner known in the art, and drops the switched connection at step 198.

Meanwhile, the MCU 50 in the telephone interface 16 moves to a wait state at step 200, in preparation for another call to be made, or a ringing event to be received. If no further instructions are received during the timeout period, the MCU 50 shuts down the RF link by disabling the GMSK radio module 58 and SST 56, then goes to sleep at step 202.

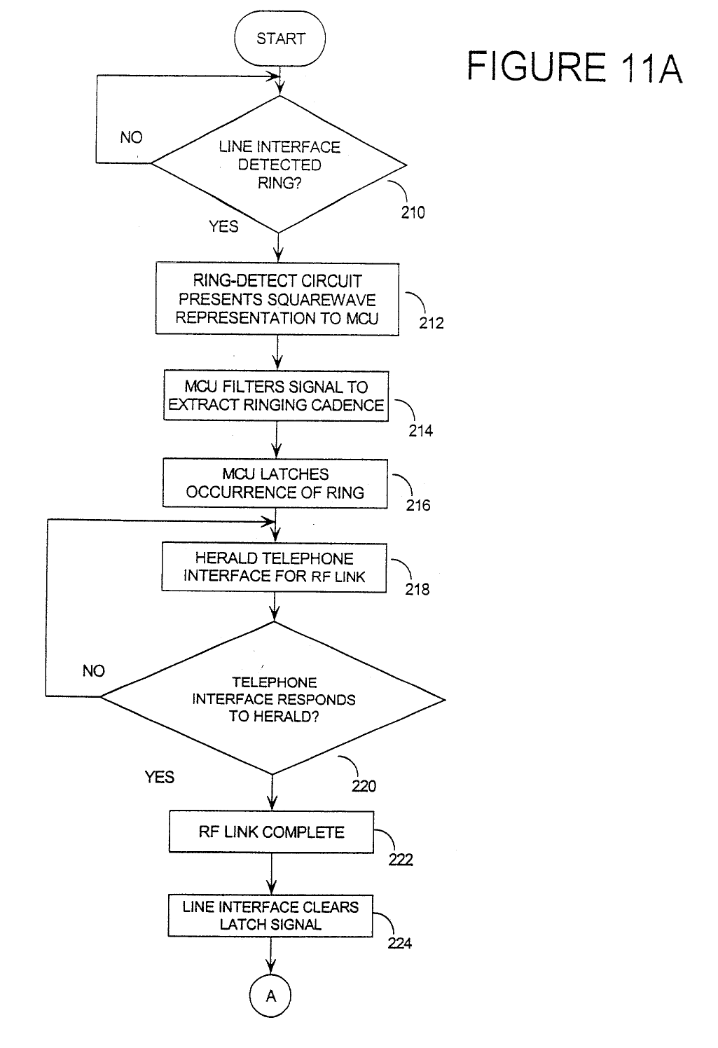

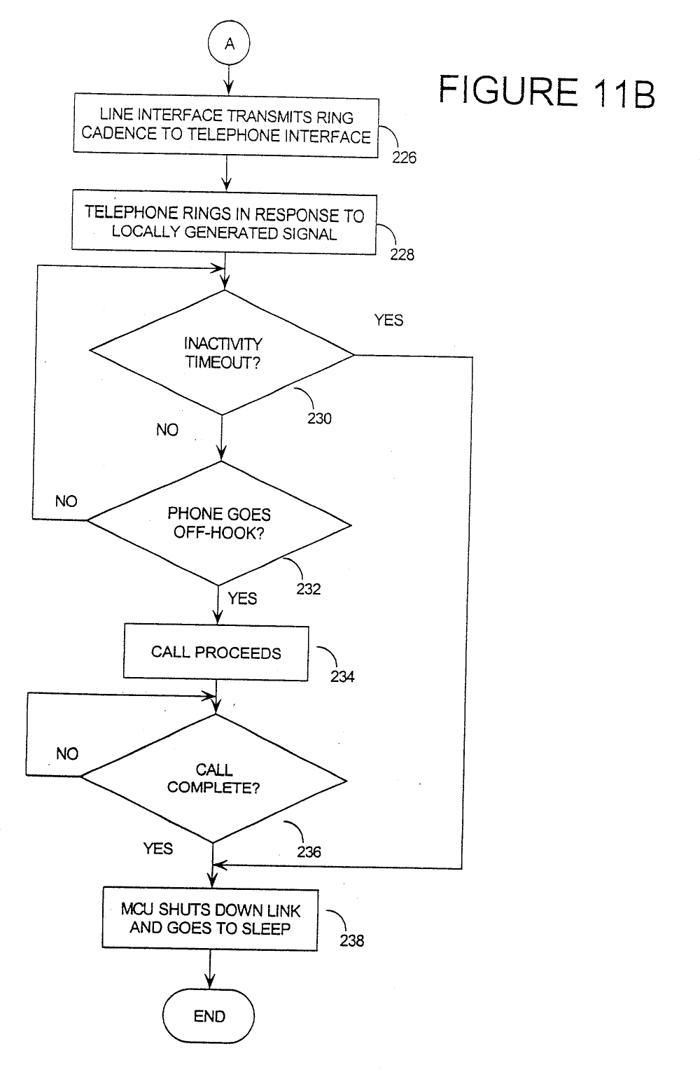

Finally, FIGS. 11a and 11b present a flow chart of the preferred method of operation when the central office presents a ringing signal to the line interface 18. Because the line interface 18 is connected to a standard PSTN telephone outlet, it emulates a regular telephone from the perspective of the PSTN 14. Thus, when a call arrives from the PSTN 14, at the line interface 18, it receives this notice as a ringing signal. This ringing signal is detected by the ring detector 108, at step 210, and it passes notification off to the MCU 50 as a square wave at step 212. The MCU 50 filters this signal and extracts the cadence of the ringing at step 214, and then sets an internal latch to note the occurrence of the ring at step 216. The line interface 18 will then continuously herald the telephone interface 16 for an RF link at step 218, until it responds at step 220. Periodically (nominally each 6 seconds), the telephone interface 16 awakes and responds to the heralding to check for changes in ringing status (status signal). Note that the entire first ringing cadence cycle may be missed due to the potential 6 second latency. In cases where the ringing signal is not active, the telephone interface 16 shuts-down the RF link and resumes sleeping. However, in this case the latched ringing signal is active (regardless of the ringing cadence) so the telephone interface 16 remains awake.

The establishment of the RF link (by the telephone interface 16) at step 222 causes the line interface 18 to clear the latched ringing signal at step 224 and then pass the ringing cadence on to the telephone interface 16 at step 226 of FIG. 11b.

The ringing cadence signal received by the telephone interface 16 controls the state of the SLIC 82, which locally generates a ringing signal that is passed on to the telephone 12 at step 228.

After a period of inactivity (nominally 6 seconds) is detected at step 230, the MCU 50 shuts down the RF link by disabling the GMSK radio module 58 and SST 56 before going to sleep at step 236. Note that the quiet portion of the ringing cadence is always less than 6 seconds, therefore while ringing, the MCU 50 will not shut-down the link.

If the recipient goes off-hook at step 232, the line interface 18 relay mimics this state to alert the central office of the off-hook condition. The call then commences at step 234 in full audio duplex, until the call is completed by one of the parties going off hook at step 236. The MCU 50 then shuts down the RF link and goes to sleep at step 238.

This completes the calling operation.

While particular embodiments of the present invention have been shown and described, it is clear that changes and modifications may be made to such embodiments without departing from the true scope and spirit of the invention.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor, ASIC or similar device programmed in the manner of method steps, or may be executed by an electronic system which is provided with means for executing these steps. Similarly, an electronic memory medium such a computer diskette, CD-Rom, Random Access Memory (RAM), Read Only Memory (ROM) or similar computer software storage media known in the art, can store code which many be executed to perform such method steps. As well, electronic signals representing these method steps may also be transmitted via a communication network.

As noted above, the invention may be used in many environments and for many applications including: construction sites, sporting events, exhibitions, site testing, site evaluation, demonstrations, rural water and sewage utility systems, house to barn in an agricultural environment, road side telephones, police and fire department communications, institutional public phone and wireless last mile. As well, successive pairings of interfaces 16, 18 may be used to extend range, or to avoid a line-of-sight obstruction. Many other applications would be clear to one skilled in the art.

It would also be clear to one skilled in the art that this invention need not be limited to the communication devices described herein.

What is claimed is:

1. A stand-alone communication interface comprising:
a convertor for receiving audio signals including in-band DTMF signals, from a telephony device and converting said received signals into digital data; and
a point to point wireless transmitter for receiving said digital data and transmitting said digital data at a radio frequency via an external antenna.

2. The interface as claimed in claim 1, further comprising:
a telephone line jack, electrically connected to said convertor, allowing for removable connection of said telephony device.

3. The interface as claimed in claim 2, further comprising:
an antenna jack, electrically connected to said point to point wireless transmitter, allowing for removable connection of said antenna.

4. An interface as claimed in claim 1, wherein said convertor comprises a sampler for performing waveform coding.

5. An interface as claimed in claim 4, wherein said wave form coding convertor comprises a pulse code modulation convertor.

6. An interface as claimed in claim 5, wherein said pulse code modulation convertor comprises an adaptive differential pulse code modulation convertor (ADPCM).

7. An interface as claimed in claim 1, further comprising a spread spectrum encoder for encoding said digital data.

8. An interface as claimed in claim 7, wherein said spread spectrum encoder comprises a direct sequence spread spectrum transmitter.

9. An interface as claimed in claim 1, wherein said transmitter comprises a Gaussian minimum shift keying (GMSK) modulator.

10. An interface as claimed in claim 9, wherein said modulator comprises a modulator for transmitting in an unlicensed frequency band.

11. An interface as claimed in claim 10, wherein said modulator comprises a modulator for transmitting in an Instrumentation, Scientific, and Medical (ISM) frequency band.

12. An interface as claimed in claim 1, wherein said external telephone device is a pay telephone.

13. An interface as claimed in claim 1, further comprising a source of direct current (DC) power.

14. An interface as claimed in claim 1, wherein said convertor comprises a tip/ring reversal signalling interface.

15. An interface as claimed in claim 1, wherein said convertor comprises a means for encoding out-of-band signals.

16. An interface as claimed in claim 1, wherein said transmitter comprises a transmitter for transmitting in time domain duplex (TDO), enabling two way communication in a single frequency channel.

17. An interface as claimed in claim 1, further comprising a 14.4 kbps digital modem transmitter for transmitting payphone operational data.

18. A stand-alone communication interface comprising:
convertor means for receiving audio signals including in-band DTMF signals, from a telephony device and converting said received signals into digital data; and
point to point wireless transmitter means for receiving said digital data and transmitting said digital data at a radio frequency via an external antenna.

19. A method of operating a stand-alone communication interface comprising the steps of:
receiving audio signals including in-band DTMF signals, from a telephony device;
converting said received signals into digital data; and
transmitting said digital data at a radio frequency, using point to point wireless via an external antenna.

20. A method of operating a stand-alone communication interface comprising the steps of:
receiving digital data at a radio frequency, using point to point wireless via an external antenna;
converting said digital data into audio signals including in-band DTMF signals; and
passing said audio signals including in-band DTMF signals to a telephony device.

21. A method of operating a stand-alone communication interface comprising the steps of:
receiving audio signals including in-band DTMF signals, from a public switched telephone network;
converting said received signals into digital data; and
transmitting said digital data at a radio frequency, using point to point wireless via an external antenna.

22. A method of operating a stand-alone communication interface comprising the steps of:
receiving digital data at a radio frequency, using point to point wireless via an external antenna;
converting said digital data into audio signals including in-band DTMF signals; and
passing said audio signals including in-band DTMF signals to a public switched telephone network.
